(19) United States
(12) Patent Application Publication
(10) Pub. No.: US 2007/0008813 A1
(43) Pub. Date: Jan. 11, 2007

(54) Apparatus for foaming a slurry

(76) Inventor: Norbert Kranzinger, Neumark (AT)

Correspondence Address: WILLIAM COLLARD;COLLARD & ROE, P.C., 1077 NORTHERN BOULEVARD, ROSLYN, NY, 11576, US

(21) Appl. No.: 10/558,309

(22) PCT Filed: May 14, 2004
(86) PCT No.: PCT/AT04/00170

§ 371 Date: Nov. 28, 2005

(30) Foreign Application Priority Data
May 27, 2003 (AT) A815/2003

(51) Int. Cl. B01F 7/32

(52) U.S. Cl. 366/65; 366/66; 366/297; 366/325.8

(57) ABSTRACT

An apparatus is described for foaming a slurry made of sand, water and a hydraulic binding medium by adding a foaming agent with a cylindrical vessel (2) for receiving the slurry and an agitator (7) revolving relative to the vessel about the vessel axis. In order to provide simple constructional conditions it is proposed that the agitator (7) comprises agitating units (10) distributed over the cross section of the vessel, which agitating units each consist of a rotor parallel to the vessel axis with agitator rods (14) between retainers (12, 13) on the face side, which rods are distributed over the circumference, are parallel to the axis and can be driven in an alternating manner in opposite directions.

### FIELD OF THE INVENTION

The invention relates to an apparatus for foaming a slurry made of sand, water and a hydraulic binding medium by adding a foaming agent with a cylindrical vessel for receiving the slurry and an agitator revolving relative to the vessel about the vessel axis.

### DESCRIPTION OF THE PRIOR ART

In the production of insulating materials and aggregates for the construction industry from sands bound with hydraulic binding mediums, e.g. quartz sand or sand-lime, a slurry is formed from the sands, the hydraulic binding agent and the water, which is foamed prior to hardening. It is known for this purpose to add an aluminum powder as an expanding agent to the slurry, which powder splits the water into hydrogen and oxygen and thus provides propellants leading to the formation of pores in the slurry. The hardening of the foamed slurry occurs under the influence of heat and pressure in autoclaves. The disadvantageous effect in this known production of such porous building materials and aggregates is, apart from the comparatively high production effort, that the size of the forming pores can hardly be controlled and it is only possible to take an influence on the pore distribution within the foaming slurry with difficulty.

Tests to avoid these difficulties by mechanical foaming of the slurry by adding a foaming agent such as ionogenic tensides have shown such slurries can only be foamed insufficiently with conventional agitators. It was only managed to achieve half of a desired minimum porosity of 80 percent by volume.

### SUMMARY OF THE INVENTION

The invention is thus based on the object of providing an apparatus for foaming a slurry made of sand, water and a hydraulic binding medium by the addition of a foaming agent of the kind mentioned above in such a way that an even foaming of the slurry with a minimum pore share of 80 percent by volume can be ensured.

This object is achieved by the present invention in such a way that the agitator comprises agitating units distributed over the cross section of the vessel, which agitating units each consist of a rotor parallel to the vessel axis with agitator rods between retainers on the face side, which rods are distributed over the circumference, are parallel to the axis and can be driven in an alternating manner in opposite directions.

By providing agitating units with agitator rods which are parallel to their rotational axis it is possible to advantageously introduce air into the slurry. The diameter of the agitator rods determines the size of the introduced air bubbles and thus the later pores. The later pore size can be predetermined by the diameter of the employed agitator rods, with thinner agitator rods leading to finer air bubbles and larger agitator rods leading to larger air bubbles. The rotational speed of the agitator rods of the individual agitating units has a direct influence on the rate of the air introduced into the slurry and thus on the share of pores. Since the agitating units of the agitator are driven in opposite directions, a conveying effect on the slurry to be foamed occurs between adjacent agitating units. The slurry is sucked in on the side of rods of adjacent rotors rotating into the interstitial region and is ejected on the opposite side of the interstitial region. This conveying effect ensures in combination with the relative rotation between the entire agitator and the vessel an even inclusion of the entire slurry mass and thus an even distribution of pores over the foamed slurry. When making a respective choice of the rotational speed of the agitator rods, air can be introduced in a quantity which makes up at least 80 percent by volume of the foamed slurry even in the case of slurries whose shares of solids have a higher density than water; this occurs under an even distribution of the air bubbles whose size depends substantially on the diameter of the employed agitator rods. The foam structure of the foamed slurry is surprisingly sufficiently stable until the setting of the hydraulic binding medium within the slurry prevents a collapse of the foam, namely under the usual ambient conditions without the addition of any additional thermal energy, which may be supplied in any case however to accelerate the setting. In order to enable driving the rotors of the individual agitating units in an alternating manner in opposite directions, the rotors can comprise drive shafts which are operatively connected at least in groups by way of mutually combing gearwheels. The mutually combing gearwheels of adjacent rotors ensure the opposite direction of rotation of adjacent agitating units. The fact that the mutual distance of the agitating units cooperating in pairs is preferably chosen in a uniform way benefits the drive of the rotors by mutually engaging gearwheels.

In order to provide simple constructional conditions, the retainers for the agitator rods can sit on the drive shafts of the agitating units. The agitator rods of the agitating units enclose the respective drive shaft in at least one concentric pitch circle. If the agitator rods are arranged in two or more pitch circles then it is recommended to mutually offset the agitator rods of the individual pitch circles to form a gap relative to the agitator rods of adjacent pitch circles. This allows an even introduction of the air into the slurry in combination with favorable conveying conditions for the slurry.

As a result of the conveying effect of the agitating units cooperating in pairs on the slurry to be foamed, congestion effects can occur in the intake region of two adjacent agitating units, which congestion effects obstruct the even advance of the slurry between adjacent agitating units. To ensure that such congestion effects cannot have a disadvantageous effect on the air introduction into the slurry, the relative direction of rotation between the vessel and the agitator can be reversed, so that in the case of a repeated reversal of the direction of rotation of the vessel any congestion regions in the intake region between two agitating units are dissolved when an opposite conveying component acts upon the slurry as a result of the direction of rotation of the vessel contrary to the intake direction. In contrast to a reversal of the direction of rotation of the agitating units, a reversal of the movement of the relative rotation between the vessel and the agitator does not disturb the continued even introduction of air into the slurry.

Since the rate of air introduction changes with the degree of foaming of the slurry at the same rotational speed of the agitator rods, the introduction of air can be controlled depending on the degree of foaming by the rotational speed of the agitator rods, so that the introduced air quantity can be increased, reduced or kept constant with increasing foaming of the slurry depending on the respective requirements.

### BRIEF DESCRIPTION OF THE DRAWINGS

The subject matter of the invention is shown in the drawings by way of example, wherein:

FIG. 1 shows an apparatus in accordance with the invention for foaming a slurry in a simplified axial sectional view;

FIG. 2 shows this apparatus in a top view;

FIG. 3 shows an agitating unit in an axial sectional view on an enlarged scale, and

FIG. 4 shows said agitating unit in a sectional view along the line IV-IV of FIG. 3.

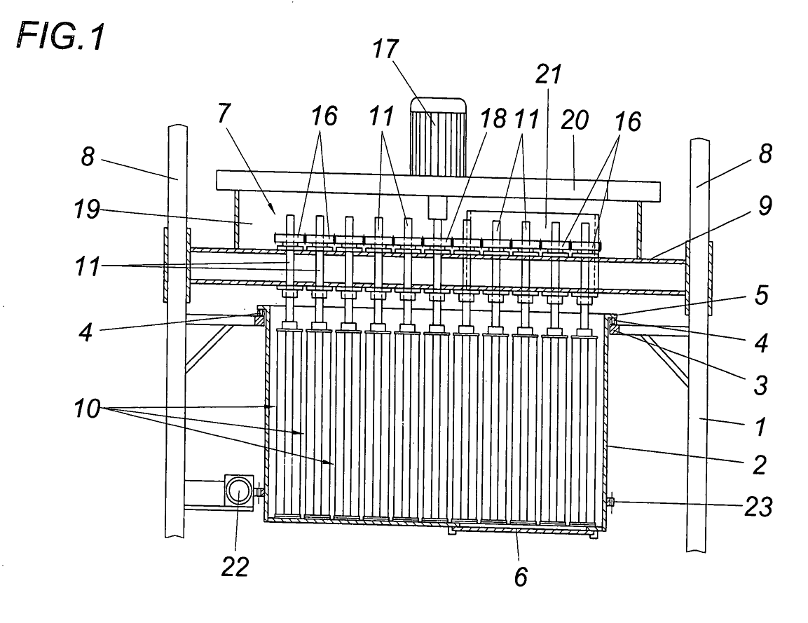

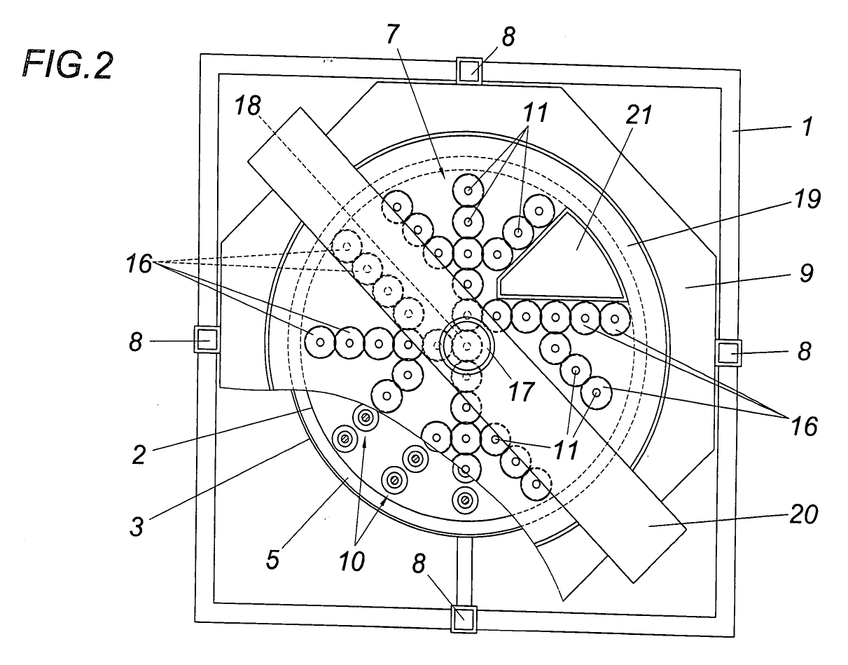

### DESCRIPTION OF THE PREFERRED EMBODIMENTS

The illustrated apparatus for foaming a slurry comprises a frame 1 in which a cylindrical vessel 2 is rotatably held about the vessel axis for receiving the slurry to be foamed. For this purpose the frame 1 forms a carrying ring 3 into which the vessel 2 is hooked. Track rollers 4 are provided for supporting the vessel 2 on the carrying ring 3. The vessel 2 rests on the same via a boundary flange 5. A device 6 for discharging the foamed slurry in the form of a discharge slide is provided in the floor of the vessel 2.

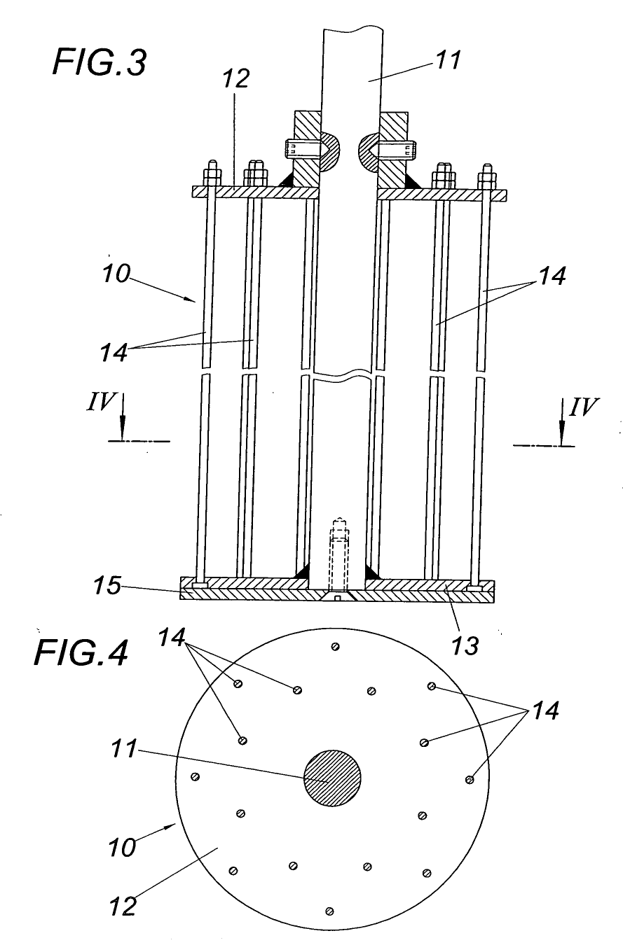

An agitator 7 is used for foaming the slurry, which agitator is held in a carriage 9 being vertically adjustable on guide pillars 8 and consists of a plurality of agitating units 10. Said agitating units 10 form rotors which are parallel to the vessel axis and which each consists of a drive shaft 11 according to FIGS. 3 and 4 on which disk-like retainers 12 and 13, between which the axially parallel agitator rods 14 are arranged. Said agitator rods 14 which are preferably formed by wires stretched between the retainers 12 and 13 are evenly distributed in concentric pitch circles about the drive shafts 11. Since the air volume introduced via these agitating units 10 not only depends on the rotational speed of the agitator rods 14 but also on their number, it is recommended to arrange the agitating rods in at least two concentric pitch circles for higher introduction performance, since the rotational speed of the agitating rods is limited as a result of the centrifugal forces acting upon the slurry to be foamed. In the case of an arrangement of agitator rods 14 in two pitch circles, the agitating rods 14 of the two pitch circles are offset relative to each other to form a gap, as is shown in FIG. 4 in order to ensure an even introduction of air.

Since the agitating units 10 project with their lower retainers 13 up to the floor region of the vessel 2, a respective wear and tear of the retainers 13 must be expected. In order to take such wear and tear into account, the lower retainers 13 can be covered with exchangeable wearing plates 15 which are screwed together with the shaft 11 according to FIG. 3.

The agitating units 10 are rotatably held in the carriage 9 and carry gearwheels 16 on the ends projecting upwardly beyond the carriage 9. The arrangement is made in such a way that the gearwheels 16 of adjacent drive shafts 11 of the agitating units 10 combined into groups comb with one another, so that the agitating units 11 of each group are driven in an alternating manner in opposite directions. The drive per se occurs via a motor 17 which drives the gearwheels 16 of the respective innermost agitating units 10 of the individual group of agitating units via a gearwheel 18 which is coaxial to the vessel axis. It is understood that the central gearwheel 18 can also be connected with an agitating unit 10.

The gearwheels 16 are arranged in an oil-filled gear trough 19 in order to ensure simple lubrication for the gearwheels 16. The motor 17 is supported on a carrier 20 bridging the gear trough 19.

To ensure that the agitator 7 does not have to be lifted from the vessel 2 via the carriage 8 for filling the vessel 2, the carriage 9 is penetrated by a filling chute 21 which is provided between two groups of agitating units 10 and projects through the gear trough 19. The slurry to be treated is filled into the vessel 2 through the filling chute 21, which slurry is mixed for example from 170 to 260 kg of a fine-grained sand meal, 30 to 50 kg of a sand with an average grain size of between 70 to 200 μm and a maximum grain size of up to 1 mm and 90 to 150 kg of cement by adding 120 to 200 L of water. Before a foaming agent is added to this slurry, a treatment of the slurry with the help of the agitator 7 is recommended, which for this purpose is activated during a time interval of 1 to 3 minutes for example. The vessel 2 is also made to rotate with the activation of the agitator 7, so that a treatment of the slurry can be ensured which is even over the entire volume. The rotational drive of the vessel 2 is carried out by a motor 22 which drives a pinion combing a gear rim 23 enclosing the vessel 2 and reversed in its direction of rotation. The actual foaming process occurs after the addition of the foaming agent which consists according to the embodiment of an ionogenic tenside dissolved in a quantity of 2.8 to 4.5 L in 110 to 170 L of water. The slurry laced with the hydrous foaming agent is then foamed with the help of the agitator, with the vessel 2 reversing its direction of rotation in an alternating fashion. After a treatment period of between 3 and 10 minutes, air is introduced into the slurry and the same is foamed in a fine-pored fashion. For the purpose of stabilizing the foamed slurry, the stirring process can be continued for a duration of 2 to 5 minutes, preferably at a lower circumferential speed of the agitating units 10. This aftertreatment has the purpose of improving the evenness of the pore distribution over the volume of the foamed slurry. The foamed slurry can then be removed from the vessel 2 via the discharge device 6 and can be poured for hardening into trough-like vats.

As a result of the agitating units 10 rotating in pairs in opposite directions, a conveying effect is exerted on the slurry to be foamed, which conveying effect draws the slurry into the intake interstitial region between two adjacent agitating units 10 and ejects the same on the opposite side. Air is introduced into the slurry in the suction of the agitator rods 14 which are driven with a respective rotational speed, namely in the form of fine bubbles which determine the fine-pored structure of the foam. The diameter of the agitator rods 14 determines the pore size, so that a certain pore structure can be ensured by the choice of the thickness of the agitator rods 14. Agitator rods 14 with a diameter of between 1 and 4 mm are usually used depending on the size of the pores of the foamed slurry. The rotational speed and the number of agitator rods 14 influence the introduced air quantity. The rotational speed is subject to limits due to the effects of centrifugal force on the slurry to be foamed so as to avoid driving out air that has already been introduced. The pitched circle diameters for the agitator rods 14 lie in the region of between 20 and 150 mm. The rotational speed of the agitating units 10 is usually 10 to 45 revolutions per second.

1. An apparatus for foaming a slurry of sand, water and a hydraulic binding medium by adding a foaming agent with a cylindrical vessel for receiving the slurry and an agitator (7) comprises agitating units (10) distributed over the cross section of the vessel, which agitating units each consist of a rotor parallel to the vessel axis with agitator rods (14) between retainers (12,13) on the face side, which rods are distributed over the circumference, are parallel to the axis and can be driven in an alternating manner in opposite directions.

2. An apparatus according to claim 1 wherein, the rotors of the agitator (7) comprise drive shafts (11) which are operatively connected at least in groups by way of mutually combing gearwheels (16).

3. An apparatus according to claim 1, wherein the retainers (12, 13) for the agitator rods (14) can sit on the drive shafts (11) of the agitating units (10) and that the agitator rods (14) of the agitating units (10) enclose the respective drive shaft (11) in at least one concentric pitch circle.

4. An apparatus according to claim 3, wherein the agitator rods (14) of the agitating units (10) are mutually arranged in at least two concentric pitch circles in an offset manner to form a gap with respect to the respective drive shaft (11).

5. An apparatus according to claim 1, wherein the relative direction of rotation between the vessel (2) and the agitator (7) is reversible.

6. An apparatus according to claim 1, wherein the rotational speed of the agitating units (11) is controllable depending on the degree of foaming.
